(19) United States
(12) Patent Application Publication
(10) Pub. No.: US 2008/0237083 A1
(43) Pub. Date: Oct. 2, 2008

(54) Systems and methods for providing and using medical items

(76) Inventors: Hugh W. Mahaffy, Riverside, PA (US); Doug C. Bach, Scottsdale, AZ (US); Manoel Ribeiro Coelho Neto, Apache Junction, AZ (US)

Correspondence Address: SQUIRE SANDERS & DEMPSEY LLP, TWO RENAISSANCE SQUARE, 40 NORTH CENTRAL AVENUE, SUITE 2700, PHOENIX, AZ, 85004-4498, US

(21) Appl. No.: 11/729,156

(22) Filed: Mar. 27, 2007

(51) Int. Cl. A61J 7/04

(52) U.S. Cl. 206/534

(57) ABSTRACT

A system for providing and using medical items generally includes one or more containers, each of which holds at least one medical item, wherein each of the one or more containers has an indicator identifying an intended purpose for the medical item, and wherein the intended purpose is based on a bodily system and/or a medical incident. One or more of the medical item(s), container(s) or the entire system, may be replaced automatically in predetermined time intervals.

### FIELD OF THE INVENTION

The present invention relates to systems and methods for providing and using medical items.

### BACKGROUND OF THE INVENTION

Many businesses and governmental entities carry supplies of medical items, often inside of a medical or container kit, in case of an emergency or medical incident. In places where professional medical providers and medical facilities are unavailable, such as commercial shipping vessels, airliners, golf courses, malls, military vehicles, remote camps and other places, the ability to quickly and accurately access medical items to treat a medical condition may be crucial to saving lives during an emergency. Waterborne vessels, airborne vehicles, or remote land-based applications may each require a different complement of medical items because each may be prone to specific types of emergencies. However, even if the proper medical items are available to handle the emergency, it may be difficult for a person without medical training to quickly determine which medical items are needed for a particular emergency or medical situation. In some cases, the delay in locating such an item may prove to be catastrophic for a victim requiring immediate treatment.

In addition, where kits or containers of medical items are maintained, someone must track and maintain a current and accurate inventory of medical items in the kit, due to usage and/or varying expiration dates on certain items. This can be time consuming and difficult, especially for persons that are not medical professionals.

### BRIEF SUMMARY OF THE INVENTION

One aspect of the present invention is a system for providing and using medical items. The system includes a container (or kit) holding at least one medical item, wherein the container has an indicator identifying an intended purpose for the medical item, and wherein the intended purpose is based on a bodily system and/or a type of medical incident, such as a heart or gastrointestinal problem.

Another aspect of the invention is a method that generally includes automatically replenishing, on a preset time schedule (which can vary or be changed), at least one medical item in the container, or the container in its entirety.

Both the foregoing general description and the following detailed description are exemplary and explanatory only and are not restrictive of the invention as claimed.

### BRIEF DESCRIPTION OF THE DRAWINGS

FIG. 1 is a perspective view of exemplary embodiments of containers for holding medical items according to the present invention.

FIG. 2 is a top view of exemplary embodiments of containers according to the present invention.

FIG. 3 is a top view of an exemplary configuration for a fully opened container according to the present invention.

FIG. 4 is a top view of an exemplary embodiment of a package holding medical items, wherein the package would be included in a container according to the invention.

FIG. 5 is a top view showing the medical items separated from the exemplary package depicted in FIG. 4.

FIG. 6 illustrates an exemplary process for using medical items according to the present invention.

FIG. 7 illustrates an exemplary process for using medical items according to the present invention.

FIG. 8 illustrates an exemplary process for providing medical items according to the present invention.

Elements in the figures have not necessarily been drawn to scale.

### DETAILED DESCRIPTION OF EXEMPLARY EMBODIMENTS

The systems and methods introduced herein summarize exemplary embodiments of the present invention. Embodiments of the present invention may be constructed using any suitable materials, or manufacturing processes. Furthermore, the present invention may be practiced in conjunction with any number of other processes, systems, and/or devices.

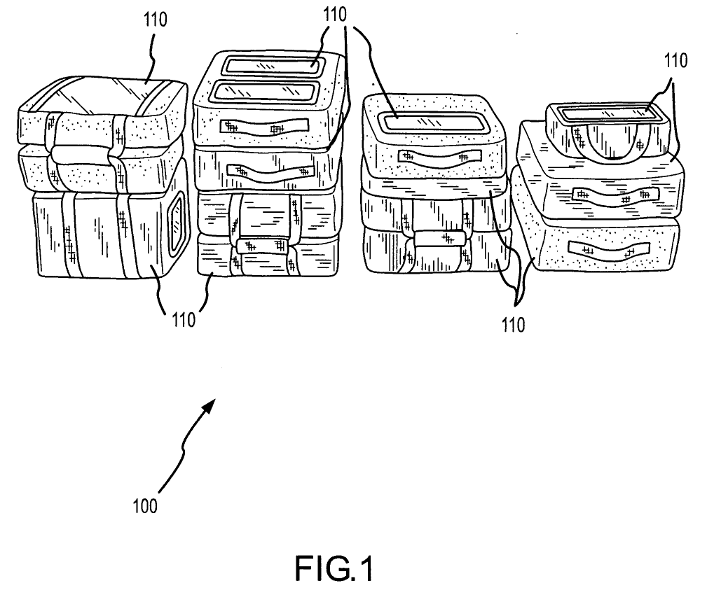

Referring to FIG. 1, a system 100 for providing and using medical items may comprise one or more containers (or kits) 110 that include medical items 210. Containers 110 may be of any size, shape, dimension and/or configuration and constructed from any suitable material(s) to achieve any desired purpose. For example, a container 110 may comprise a water-resistant and/or flame-resistant material. Additionally, the material of a container 110 may be selected to conform to one or more regulatory schemes, such as Federal Aviation Administration (FAA) regulations regarding materials used on aircraft. The system 100 as depicted in FIG. 1 includes a plurality of containers of varying dimension.

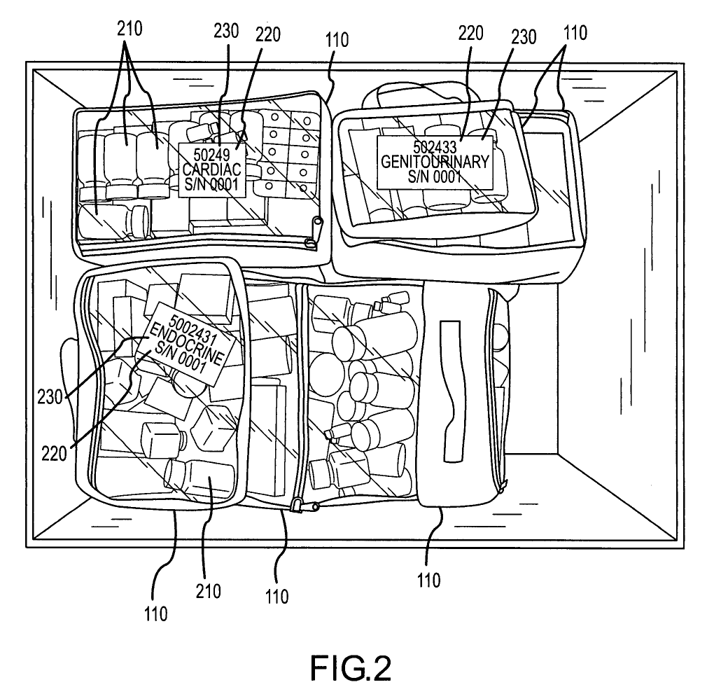

Referring to FIG. 2, a container 110 contains one or more medical items 210. The container 110 may hold any appropriate number and type of medical items 210. A medical item 210 is any suitable item related to the practice of medicine, treatment of a disease and/or medical condition. For example, a container 110 may hold any pharmaceutical, medical device, surgical equipment, and/or diagnostic equipment. A medical item 210 can treat any suitable bodily system and medical condition, and may treat any species of living being. Medical items 210 may be selected according to any suitable criteria, such as types of specific body areas or medical conditions to be treated. Additionally, medical items 210 may be selected according to existing, recognized maritime medical formularies, such as maritime standards or current medical standards of care, summaries of medical incident data in certain locations or situations, or other criteria.

Each container 110 includes one or more indicators 220 to provide information about the medical item 210. An indicator 220 provides information regarding at least one medical item 210 within a container 110. The indicator 220 may identify the number and/or type of medical items 210 in a container 110, and/or provide any other appropriate information about one or more medical items 210, such as the bodily system and/or the medical condition the medical item(s) 210 is designed to treat. The indicator 220 may include any number of words, symbols, colors, textures, Braille characters or other designators.

For example, in one embodiment of a container 110, an indicator 220 comprises one or more colors, which could be coloring applied to the material forming the container 110. The coloring may cover any portion of the container to provide any desired information. For example, a container 110 having six sides may have coloring on all or part of one or more (perhaps four) sides most likely to be seen by a user when container 110 is stored or stacked as part of a larger system of containers 110. If coloring is used as an indicator 220, it may be luminescent to allow the container to be seen in the dark. An indicator 220 may comprise any other suitable visual indicator to aid in the identification of the medical items 210 it contains, such as the shape of the container 110.

In another exemplary embodiment, an indicator 220 may comprise a content card 230 that includes information about medical items 210 in the container 210. The content card 230 may be connected to or placed within a container 110 in any suitable manner, such as placed inside of a transparent pouch attached to container 110. The content card 230 may include instructions in any number of languages, and may include any symbol, picture, coloring, generic product name, or other indicia to explain the purpose and/or function of one or more medical items 210.

Any number of indicators 210 may be used simultaneously in conjunction with a container 110. For example, a container 110 may include both a coloring and a content card 230. Multiple indicators 220 may complement each other, or provide different functions altogether. For example, a content card 230 held in a transparent pouch connected to a container 110 may be of the same color as the exterior of the container 110.

In the exemplary embodiment of a system for providing and using medical items 100 depicted in FIG. 1, the plurality of containers 110 may be of different colors in order to differentiate separate categories of medical item 210 contained in each container 110. Additionally, an indicator 220 may also be included on medical items 210 themselves. For example, one or more medical items 210 may comprise a tracking number and/or unique product identifier to provide an additional cross-reference for shipboard medical personnel, or may include instructions or a color to indicate the intended use. Indicator 220 may also be used to help identify medical items 210 and aid in the ordering and tracking of medical items 210.

An indicator 220 may provide any information about one or more medical items 210. In one embodiment according to various aspects of the present invention, containers 110 include indicators 220 associated with the following medical categories: cardiac, dermatological, endocrine, gastrointestinal, genitourinary, pulmonary, head/eyes/ear/nose/throat, infectious disease and multi-use pharmacy. For example, a red-colored container may be used to indicate the medical items 210 within the container 110 are designed for treating cardiac conditions, while a brown-colored container 110 indicates medical items 210 pertaining to the gastrointestinal system of a patient. While any information about a medical item 210 may be provided by an indicator 220, a particular type of information may be provided by each indicator within a system 100 in order to standardize the association and make system 100 easier to use so as to aid in the uniform and predictable treatment of medical conditions.

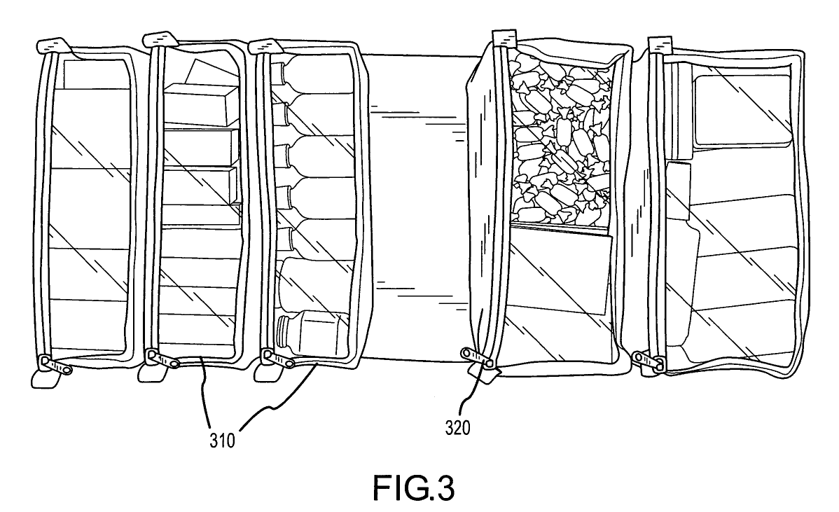

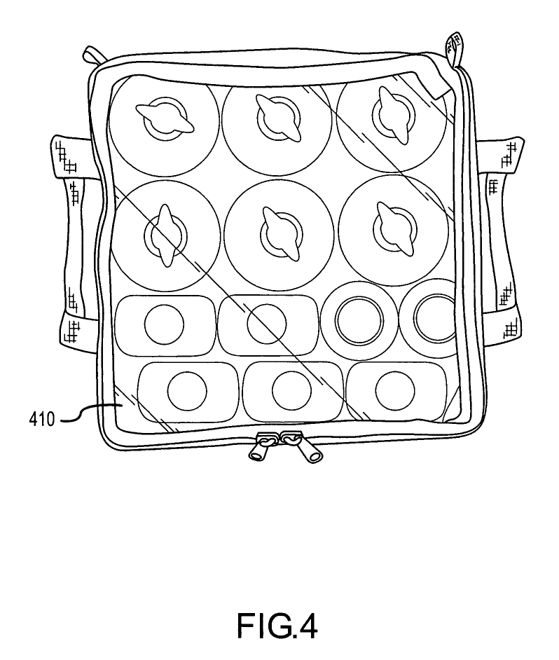

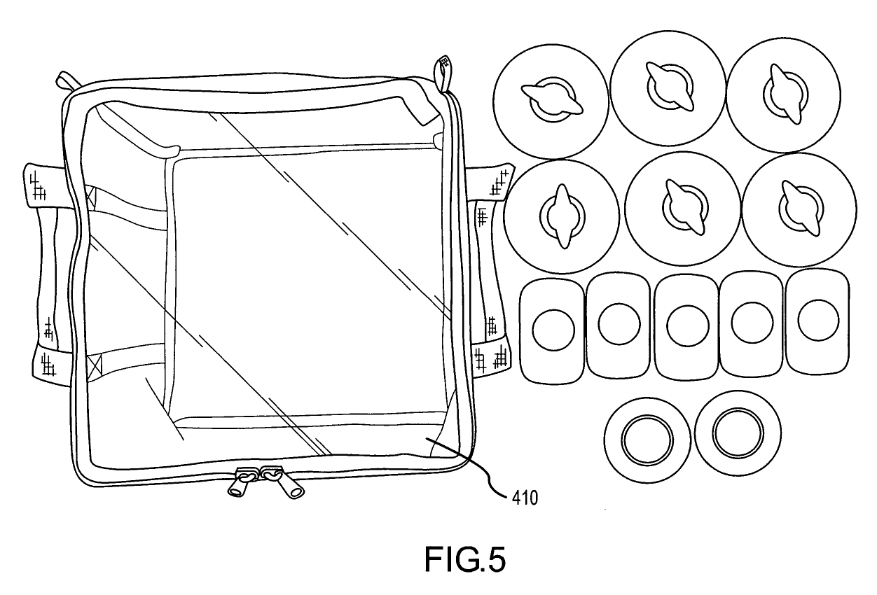

Referring to FIG. 3, a container 110 may comprise any number of subcontainers, such as one or more pouches 310 each of which can hold one or more medical items 210. A pouch 310 may be configured in any manner. A pouch 310 may comprise a zipper 320, or other opening and closing device to access medical items 210 within the pouch 310, and/or a transparent exterior portion to allow for visual inspection of one or more medical items 210. A container 110 may be configured to unroll to expose one or more subcontainers, one or more of which may comprise transparent pouches 310. Any of the containers or subcontainers may be configured to hang on a wall or medical locker to allow for the access and/or display medical items 210 inside of container 110. Referring to FIGS. 4 and 5, the container 110 itself may comprise a transparent flap 410 to allow medical items 210 within the container 110 to be viewed. One or more containers 110 of a system 100 may be configured to be stored and/or displayed in any manner. For example, the dimensions of a container 110 may be selected to fit within a medical locker or other storage area, such as the storage area inside of a vehicle.

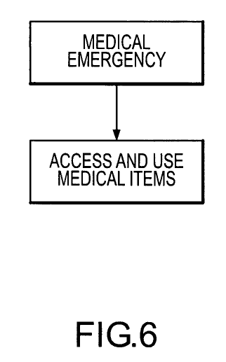

A system for using and providing medical items 100 may be utilized in any suitable manner for administering first aid, medicine or otherwise providing medical assistance. As shown in FIG. 6, utilizing the most basic method according to the present invention, a person accesses a system 100 in case another person (i.e., a “patient”) requires medical care, and the person assists the patient or administers medications and/or medical therapies to the patient utilizing the system 100. The one or more indicators 220 in the system 100 assist the person in rapidly finding the proper medical items 210 for the particular medical condition to be treated.

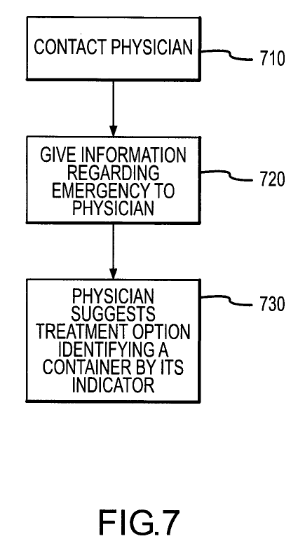

Another exemplary process for using a medical item according to the invention is depicted in FIG. 7. In this example, a person without medical training may (although not necessarily) be assisted in treating a bodily system and/or medical condition. When a medical emergency or condition (collectively, “emergency”) occurs, a person seeking to treat a patient contacts (710) a physician or other medical provider (collectively, “physician”), who is preferably familiar with system 100 for providing and using medical items 100. The person (or “care provider”) may communicate with a physician using any suitable method of communication, such as telephone, radio or the Internet. The physician may ask the care provider any suitable questions about the nature of the emergency, including the condition of the patient, exhibited symptoms and cause of injury or illness (if relevant) (720). The physician may then recommend one or more treatment options using one or more medical items 210 contained in one or more containers 110 from system 100. If the physician is familiar with system 100 he/she may identify an indicator 220 of a container 110 (730). For example, in the case of chest pain, a physician may recommend that the care provider access nitroglycerin medication from a container 110 having a red coloring indicative of cardiac medical items 210. The physician may provide any appropriate recommendation, such as how to administer a pharmaceutical and the quantity to administer. The same container 110 may include an information card 230 that lists the containers contents.

The process depicted in FIG. 7 is merely illustrative of one possible manner of using a system 100 for providing and using medical items 210. For example, a licensed provider who does not require the guidance from a doctor on treatment options may directly select a medical item 210 from a container 110 by the container's 110 indicator 220.

Another aspect of the invention is providing automatic replacement of medical items 210 based on a predetermined schedule. In some cases, a system 100 may be provided at places where professional medial care is not immediately available and/or is used by persons who are not medical professionals. A system 100 should preferably contain an adequate supply of medical items 210 that are not expired. For example, a system 100 according to the present invention may include a supply of medical items 210 for a range of between six to twelve months. To alleviate the need for taking and tracking the inventory and expiration dates of medical items 210, a method according to the present invention automatically replenishes all or a portion of the medical items 210 in a system 100 on a preset (or predetermined) schedule. This schedule may be different for different medical items 210, and it may be altered depending upon usage or other factors. In an exemplary embodiment, a replacement container 110 is periodically sent to replace a container 110 already in system 100 or the entire system 100 is periodically replaced. A replacement container 110 may be provided at any period, such as annually, quarterly, or at any other suitable interval.

If a replacement container 110 is sent, it is placed in system 100 and the replaced container 110 is either returned to the person or entity that sent the replacement container 110, or is otherwise disposed. Disposing of a container 110 may be performed in any suitable manner, such as by destroying of the container 110 beyond the reclamation and use by the user. Replacement is simple because the replacement container 110 and replaced container 110 preferably have the same physical appearance and indicator 220. So, a user needs only to remove the replaced container and insert the replacement container from a system 100. Alternatively, and as previously mentioned, all of a system 100 can be replaced on a predetermined schedule that may be varied, or specific medical items 210 may be replaced on a periodic basis.

The owner or user of a system 100 (a “subscriber”) may specify the period of time from the ship date of a system 100 that it wishes to receive a replacement system or determine the replacement date based on some other criteria, such as anticipated or actual usage. The providing of the replacement system 100 may occur automatically, in order to relieve the subscriber of the burden of tracking expiration dates and quantities of various medical items 210. As previously mentioned, portions of a system 100 may be automatically replaced at any appropriate time interval. For example, a pouch 310 containing one or more medical items 210 that has a shorter expiration date and/or greater usage than other medical items 210 may be automatically replaced at a shorter time interval than other medical items 210. A subscriber may also expressly order any replacement medical item 210 outside the scheduled replacement dates.

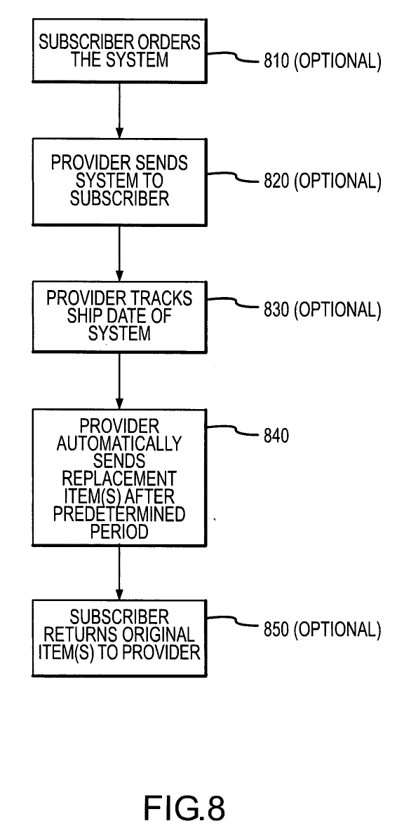

An exemplary process for providing medical items 210 is illustrated in FIG. 8. In this exemplary process, a subscriber orders one or more systems 100 for providing medical items 210 (810). A subscriber may order such a system 100 in any manner, such as through a web site accessed over the Internet, by telephone, by facsimile, or using any other method of communication. The system 100 is then delivered (820) to the subscriber in any suitable manner. The medical items 210 in system 100 may be determined in any manner. For example, they may be selected according to any suitable regulatory standard, configuration of content, or certification. For example, a provider may deliver a system 100 configured to comply with the Authorized Minimal Medical Allowance Lists (AMMAL) proscribed by the United States Navy to a subscriber operating a waterborne vessel. Similarly, a system 100 for aviation applications may be configured to comply with FAA regulations. System 100 may be configured to include any medical items 210. For example, a system 100 may be customized and/or supplemented with medical items 210 to accommodate a subscriber operating primarily in coastal regions, but who may also make occasional trans-ocean voyages.

The entity that provided, or that is responsible for directly or indirectly sending replacement medical items 210, containers 110 and/or systems 100, tracks either the ship date of system 100 (830), or otherwise tracks the date on which replacement medical items 210, containers 110 and/or systems 100 are to be shipped, and automatically ships one or more replacement medical items 210, one or more replacement containers 110 or an entire replacement system(s) 100 to the subscriber (840). The subscriber may handle the replaced medical item(s) 210, container(s) 110 or system(s) 100 in any manner. For example, the subscriber may return the replaced medical item(s) 210, container(s) 110 or system(s) 100 to the provider for recycling and/or proper disposal of medical items 210 using a pre-paid shipping label provided by the provider (850).

Any portion of a method for providing medical items 210, such as automatic replacement (840), may be accomplished in any manner, such as by using computer software operating on a computer system. The software may be configured to automatically track the shipping dates of one or more systems 100 to one or more subscribers, automatically issue orders for replacement medical items 210 and/or containers 110 and/or entire systems 100.

The particular implementations shown and described above are illustrative of the invention and its best mode and are not intended to limit the scope of the present invention in any way. Changes and modifications may be made to the disclosed embodiments without departing from the scope of the present invention. These and other changes or modifications are intended to be included within the scope of the present invention, as expressed in the following claims.

What is claimed is:

1. A system comprising:
a container holding at least one medical item, wherein the container has an indicator identifying an intended purpose for the medical item, and
wherein the intended purpose is based on at least one of a bodily system and a medical incident.

2. The system of claim 1, wherein the indicator comprises at least one of a color and a content card.

3. The system of claim 2, wherein the indicator comprises a luminescent color.

4. The system of claim 2, wherein the indicator comprises a content card held in a transparent compartment connected to the container.

5. The system of claim 1, further comprising a plurality of containers.

6. The system of claim 5, wherein at least one of the plurality of containers has an indicator that is different than the indicator of another of the plurality of containers.

7. The system of claim 1, wherein the container holds a plurality of medical items.

8. The system of claim 1, wherein the container is at least one of water resistant and fire resistant.

9. A method comprising:
providing a container holding at least one medical item, wherein the container has an indicator identifying an intended purpose for the medical item, and wherein the intended purpose is based on at least one of a bodily system and a medical incident.

10. The method of claim 9, further comprising providing the medical item in the container according to at least one of an operational profile of a vehicle carrying the container and a regulatory standard.

11. The method of claim 9, further comprising recommending a treatment using the medical item to treat at least one of a bodily system and a medical incident, wherein recommending the treatment includes identifying the container by its indicator.

12. The method of claim 9, further comprising providing a replacement container after a predetermined period of time, wherein the replacement container comprises the same indicator and medical item as the container.

13. The method of claim 12, wherein the replacement container is provided automatically.

14. The method of claim 9, wherein the indicator comprises at least one of a color and a content card.

15. The method of claim 14, wherein the indicator comprises a luminescent color.

16. The method of claim 14, wherein the indicator comprises a content card held in a transparent compartment connected to the container.

17. The method of claim 9, further comprising providing a plurality of containers.

18. The method of claim 17, wherein at least one of the plurality of containers has an indicator that is different than the indicator of another of the plurality of containers.

19. The method of claim 9, wherein the container holds a plurality of medical items.

20. The method of claim 9, wherein the container is at least one of water resistant and fire resistant.

21. A method for treating a medical condition comprising:
selecting a container holding at least one medical item, wherein the container has an indicator identifying an intended purpose for the medical item, wherein the intended purpose is based on at least one of a bodily system and a medical incident, and wherein the medical condition is associated with at least one of the bodily system and the medical incident; and
using the medical item to treat the medical condition.

22. The method of claim 21, wherein the medical item is associated with at least one of an operational profile of a vehicle carrying the container and a regulatory standard.

23. The method of claim 21, further comprising receiving a recommendation for treating the medical condition, wherein the recommendation includes an identification of the container by its indicator.

24. The method of claim 21, further comprising receiving a provided replacement container after a predetermined period of time, wherein the replacement container comprises the same indicator and medical item as the container.

25. The method of claim 24, wherein the replacement container is provided automatically.

26. The method of claim 21, wherein the indicator comprises at least one of a color and a content card.

27. The method of claim 26, wherein the indicator comprises a luminescent color.

28. The method of claim 26, wherein the indicator comprises a content card held in a transparent compartment connected to the container.

29. The method of claim 21, further comprising selecting a container from a plurality of containers.

30. The method of claim 29, wherein at least two of the plurality of containers have different indicators.

31. The method of claim 21, wherein the container holds a plurality of medical items.

32. The method of claim 21, wherein the container is at least one of water resistant and fire resistant.

33. A method for replacing one or more medical items held by a container, wherein the container comprises an indicator identifying an intended purpose for the one or more medical items, the method comprising:
providing one or more replacement medical items that replaces at least one of the one or more medical items, the one or more replacement medical items being provided according to a predetermined schedule.

34. The method of claim 33, wherein the one or more replacement medical items are provided automatically.

35. The method of claim 33, further comprising disposing of the one or more medical items replaced by the one or more replacement medical items.

36. The method of claim 33, wherein the container holds a plurality of medical items.

37. The method of claim 34, wherein the indicator comprises at least one of a color and a content card.

38. The method of claim 37, wherein the indicator comprises a luminescent color.

39. The method of claim 37, wherein the indicator comprises a content card held in a transparent compartment connected to the container.

40. The method of claim 34, wherein the intended purpose based on at least one of a bodily system and a medical incident, and wherein the medical condition is associated with at least one of the bodily system and the medical incident

41. The method of claim 33, wherein the medical item is associated with at least one of an operational profile of a vehicle carrying the container and a regulatory standard.

42. The method of claim 33, wherein a plurality of medical items are replaced according to a predetermined schedule.

43. The method of claim 42, wherein the plurality of medical items are held in a replacement container.

44. The method of claim 43, wherein the replacement container comprises the same indicator and medical item as the container.

45. The method of claim 43, wherein the replacement container is provided automatically.
